(19) United States
(12) Patent Application Publication
(10) Pub. No.: US 2026/0335838 A1
(43) Pub. Date: Oct. 29, 2026

(54) COMPOSITE SEMIPERMEABLE MEMBRANE AND METHOD FOR PRODUCING COMPOSITE SEMIPERMEABLE MEMBRANE

(71) Applicant: TORAY INDUSTRIES, INC., Tokyo (JP)

(72) Inventors: Kumiko OGAWA, Shiga (JP); Shinya MITSUI, Shiga (JP); Harutoki SHIMURA, Ehime (JP)

(73) Assignee: TORAY INDUSTRIES, INC., Tokyo (JP)

(21) Appl. No.: 19/107,132

(22) PCT Filed: Aug. 30, 2023
(86) PCT No.: PCT/JP2023/031656

§ 371 Date: Feb. 27, 2025

(30) Foreign Application Priority Data
Aug. 31, 2022 (JP) 2022-137501

(51) Int. Cl. B01D 69/12; B01D 71/56

(52) U.S. Cl. CPC B01D 69/1251; B01D 71/56

(57) ABSTRACT

The present invention relates to a composite semipermeable membrane having a microporous support layer and a separation function layer that is provided on the microporous support layer, the separation function layer having a plurality of protrusions configured from a thin film containing a cross-linked aromatic polyamide, and x and y, which are measured through TEM-EELS, satisfying the relationship y/x≥1.3. x: Average value of ratio of oxygen atoms (O) to nitrogen atoms (N) in the range of 2-25% of apparent height of protrusions. y: Average value of ratio of O to N in range of 75-98% of apparent height of protrusions.

### TECHNICAL FIELD

The present invention relates to a composite semipermeable membrane useful for selective separation of a liquid mixture, and a method for producing the same.

### BACKGROUND ART

There are various techniques for removing substances (for example, salts) dissolved in a solvent (for example, water) in relation to separation of a liquid mixture, and in recent years, membrane separation methods have been widely used as processes for energy saving and resource saving. Membranes used in the membrane separation method include a microfiltration membrane, an ultrafiltration membrane, a nanofiltration membrane, a reverse osmosis membrane, and the like, and these membranes are used, for example, to obtain drinking water from water containing salt and a harmful substance, and the like, to produce ultrapure water for industrial use, to treat wastewater, or to recover a valuable material.

Most of reverse osmosis membranes and nanofiltration membranes that are currently commercially available are composite semipermeable membranes in which a separation functional layer having separation performance such as salts is coated on a support membrane, and there are two types of composite semipermeable membranes, one having an active layer in which a gel layer and a polymer are cross-linked on the support membrane, and the other having an active layer in which a monomer is polymerized on the support membrane. Among the latter composite semipermeable membranes, a composite semipermeable membrane (see Patent Literatures 1 and 2) including a separation functional layer containing a crosslinked polyamide obtained by a polycondensation reaction of a polyfunctional amine and a polyfunctional acid halide is widely used as a separation membrane having high permeability and high selective separability.

Here, in various water treatments such as water desalination plants, an operation is generally designed such that chlorine added in a pretreatment does not come into contact with a membrane, but there is a risk that chlorine leaking due to an operational error may come into contact with the membrane, causing the membrane to oxidize and deteriorate. Therefore, in order to reduce the risk of membrane deterioration caused by the chlorine leakage and to extend a lifespan of the membrane, studies have been conducted to improve chlorine resistance of these composite semipermeable membranes.

As a method for improving the chlorine resistance, a method for improving a monomer component forming a separation functional layer (Patent Literature 3) and a method for forming a protective layer on a separation functional layer (Patent Literature 4) are known.

### CITATION LIST

### Patent Literature

Patent Literature 1: JP2007-090192A
Patent Literature 2: JP2001-259388A
Patent Literature 3: JPS63-137704A
Patent Literature 4: WO2010/096563

### SUMMARY OF INVENTION

### Technical Problem

For the purpose of improving the chlorine resistance, Patent Literature 3 discloses a composite semipermeable membrane using sodium m-phenylenediamine-4-sulfonate as a polyfunctional amine forming the separation functional layer, and Patent Literature 4 discloses a composite semipermeable membrane that uses a compound having hexafluoroalcohol as a side chain as a polyfunctional amine that forms the separation functional layer. However, although the composite semipermeable membranes described in Patent Literatures 3 and 4 have chlorine resistance, a membrane having both water permeability and removability are not obtained. Therefore, an object of the present invention is to provide a composite semipermeable membrane having high water permeability and high removability even after contact with chlorine.

### Solution to Problem

In order to achieve the above object, a composite semipermeable membrane according to the present invention includes the following configurations.
[1] A composite semipermeable membrane including: a microporous support layer; and
a separation functional layer provided on the microporous support layer, in which
the separation functional layer includes a plurality of protrusions formed of a thin film containing a crosslinked aromatic polyamide, and
the following x and y, which are measured by an electron energy-loss spectroscopy in a transmission electron microscope (TEM-EELS), satisfy a relation of y/x≥1.3,
provided that x is an average value of a ratio of oxygen atom (O)/nitrogen atom (N) in a range of 2% to 25% of an apparent height of the protrusion, and
y is an average value of the ratio of O/N in a range of 75% to 98% of the apparent height of the protrusion.
[2] The composite semipermeable membrane according to the [1], in which
y satisfies a relation of y≥0.90.
[3] The composite semipermeable membrane according to the [1] or [2], in which
x satisfies a relation of x≥0.50.
[4] The composite semipermeable membrane according to any one of the [1] to [3], in which
in the separation functional layer, a ratio of T98/T25 is 0.95 or less, provided that T98 is an average thickness of the thin film in a range of 75% to 98% of a height of the protrusion, and T25 is an average thickness of the thin film in a range of 2% to 25% of the height of the protrusion.
[5] The composite semipermeable membrane according to any one of the [1] to [4], in which
in the separation functional layer, an average number density of the protrusions having a height of one-fifth or more of a ten-point average surface roughness is 13.0 protrusions/μm or more.
[6] The composite semipermeable membrane according to any one of the [1] to [5], in which
the crosslinked aromatic polyamide includes a polyamide which is a polymer of trimesic acid chloride and m-phenylenediamine.
[7] A method for producing a composite semipermeable membrane including a microporous support layer and a separation functional layer provided on the microporous support layer, the method including:
a step of forming a layer containing a crosslinked aromatic polyamide on the microporous support layer by interfacial polycondensation using a polyfunctional aromatic amine aqueous solution and an organic solvent solution of a polyfunctional aromatic acid halide; and
a step of bringing a solution containing a compound containing an amide group into contact with the layer containing the crosslinked aromatic polyamide.
[8] An element including the composite semipermeable membrane according to any one of the [1] to [6].
[9] A fluid separation device including the composite semipermeable membrane according to any one of the [1] to [6].

### Advantageous Effects of Invention

According to the present invention, a composite semipermeable membrane is obtained which has high water permeability and exhibits high removability even after contact with chlorine.

### BRIEF DESCRIPTION OF DRAWINGS

FIG. 1 is a cross-sectional view of a composite semipermeable membrane according to an embodiment of the present invention.

FIG. 2 is a schematic view showing a structure of a protrusion formed of a thin film in a separation functional layer.

FIG. 3 is an enlarged view showing the structure of the protrusion.

FIG. 4 is a schematic diagram illustrating an apparent height of the protrusion.

### DESCRIPTION OF EMBODIMENTS

Hereinafter, embodiments of the present invention will be described in detail, but the present invention is not limited in any way by these embodiments.

The numerical range “to” includes the numerical values before and after it. For example, “0 mass % to 100 mass %” means a range from 0 mass % or more and 100 mass % or less.

### 1. Composite Semipermeable Membrane

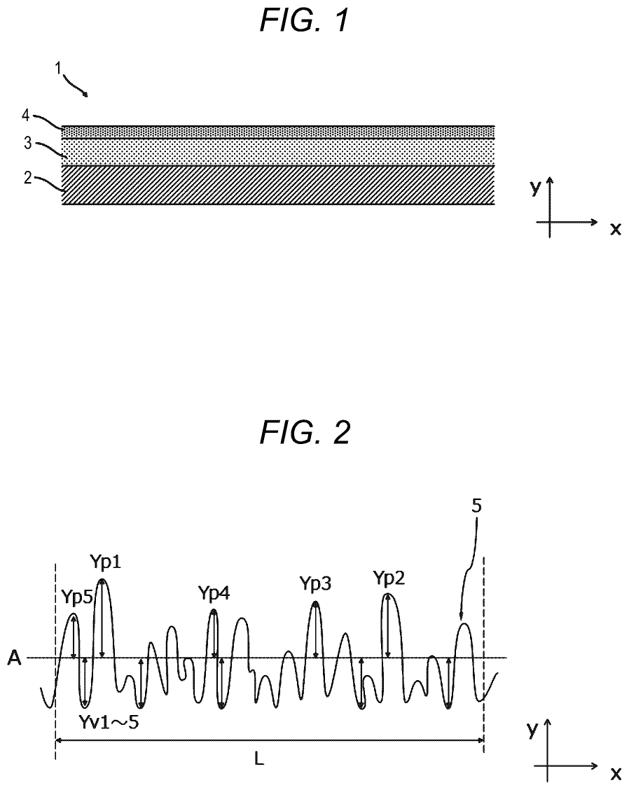

FIG. 1 shows a structure of a composite semipermeable membrane 1 according to the present embodiment. As shown in FIG. 1, the composite semipermeable membrane 1 according to the present embodiment includes a microporous support layer 3 and a separation functional layer 4 provided on the microporous support layer 3. The composite semipermeable membrane 1 may further include a substrate 2.

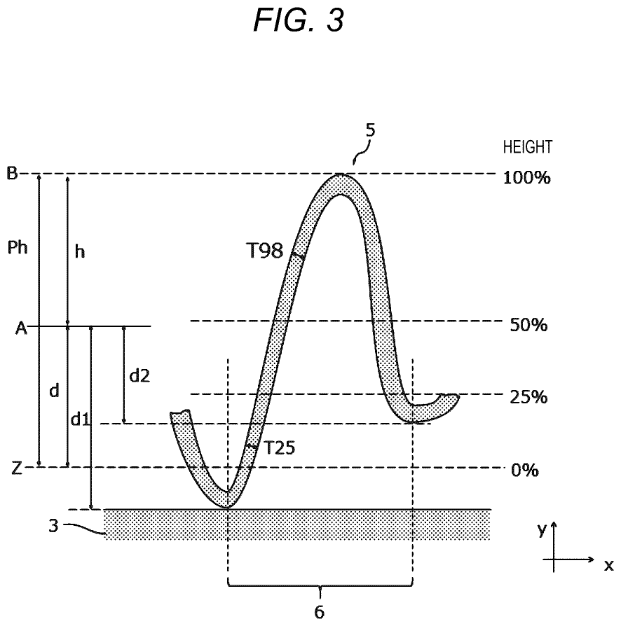

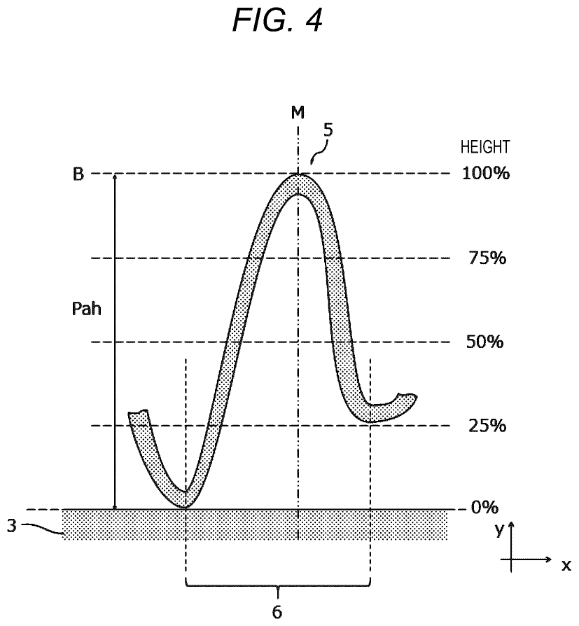

Hereinafter, a “vertical” direction means a thickness direction of a composite semipermeable membrane, that is, a direction perpendicular to a membrane surface direction of the composite semipermeable membrane, and is a y-axis direction shown in FIG. 1, FIG. 2, FIG. 3 and FIG. 4. Further, a separation functional layer is disposed “on” a microporous support layer. That is, a positive side of the y-axis is “upper” and a negative side of the y-axis is “lower”. An x-axis direction shown in FIG. 1, FIG. 2, FIG. 3 and FIG. 4 is the membrane surface direction of the composite semipermeable membrane.

The microporous support layer 3 may be formed on the substrate 2, and the composite semipermeable membrane 1 according to the embodiment of the present invention may include a support membrane including the substrate 2 and the microporous support layer 3 formed on the substrate 2.

The separation functional layer has substantial separation performance. The microporous support layer has substantially no separation performance for ions or the like, and can impart strength to the separation functional layer.

### (1-1) Support Membrane

The support membrane may include a substrate and a microporous support layer, or the support membrane may include only the microporous support layer without including the substrate. That is, the microporous support layer may be a support membrane.

Examples of the substrate include fabrics made of polyester-based polymers, polyamide-based polymers, polyolefin-based polymers and mixtures thereof, or copolymers thereof. Among them, a fabric made of polyester-based polymers having high mechanical and thermal stability is preferable. As the form of fabric, a long-fiber nonwoven fabric or a short-fiber nonwoven fabric, or a woven knitted fabric can be preferably used.

The microporous support layer has numerous fine pores that communicate from one surface thereof to an opposite surface thereof. A pore diameter and a pore diameter distribution of the fine pores in the microporous support layer are not particularly limited. For example, it is preferable that the microporous support layer has fine pores having a symmetric structure having a uniform pore diameter, or having an asymmetric structure in which the pore diameter gradually increases from one surface to the other surface, and the pore diameter on a surface having a smaller pore diameter is 0.1 nm to 100 nm.

Examples of the material of the microporous support layer include homopolymers or copolymers such as polysulfones (hereinafter referred to as “PSf”), polyethersulfones, polyamides, polyesters, cellulose-based polymers, vinyl polymers, polyphenylene sulfides, polyphenylene sulfide sulfones, polyphenylene sulfones, and polyphenylene oxides, and these can be used alone or blended for use. Examples of the cellulose-based polymers include cellulose acetate and cellulose nitrate, and examples of the vinyl polymer include polyethylene, polypropylene, polyvinyl chloride, and polyacrylonitrile. Among these, as the material for the microporous support layer, homopolymers or copolymers such as PSf, polyamides, polyesters, cellulose acetate, cellulose nitrate, polyvinyl chloride, polyacrylonitrile, polyphenylene sulfides, polyphenylene sulfide sulfones are preferable, and cellulose acetate, PSf, polyphenylene sulfide sulfones, or polyphenylene sulfones are more preferable, and PSf is particularly preferable because PSf has high chemical, mechanical, and thermal stability and is easily molded.

A weight average molecular weight (hereinafter referred to as “M.”) of PSf is preferably 10,000 to 200,000, and more preferably 15,000 to 100,000. When M. of PSf is 10,000 or more, preferable mechanical strength and heat resistance can be obtained as a microporous support layer. On the other hand, when Mw of PSf is 200,000 or less, the viscosity of a microporous support layer raw solution is in an appropriate range, and good moldability can be realized. The weight average molecular weight refers to a value in terms of polystyrene measured by gel permeation chromatography (GPC).

The thickness of the substrate and the microporous support layer influences the strength of the composite semipermeable membrane and packing density when the composite semipermeable membrane is used as an element. From the viewpoint of obtaining good mechanical strength and packing density, a total thickness of the substrate and the microporous support layer is preferably 30 μm to 300 μm, and more preferably 100 μm to 220 μm. The thickness of the microporous support layer is preferably 20 μm to 100 μm. The thickness of the substrate and the microporous support layer can be obtained by calculating a mean value of thicknesses at 20 points measured at an interval of 20 μm in a direction (surface direction of the membrane) orthogonal to a thickness direction in cross-sectional observation.

### (1-2) Separation Functional Layer

### <Composition>

The separation functional layer in the composite semipermeable membrane according to the present embodiment is a layer that functions as a solute separation function, and contains a crosslinked aromatic polyamide. The separation functional layer preferably contains a crosslinked aromatic polyamide as a main component.

The phrase “contains a crosslinked aromatic polyamide as a main component” means that a mass ratio of the crosslinked aromatic polyamide in a separation functional layer is 50 mass % or more. The mass ratio of the crosslinked aromatic polyamide in the separation functional layer is preferably 80 mass % or more, more preferably 90 mass % or more, and the separation functional layer is more preferably substantially formed of only the crosslinked aromatic polyamide. The phrase “the separation functional layer is substantially formed of only the crosslinked aromatic polyamide” means that a mass ratio of the crosslinked aromatic polyamide in the separation functional layer is 99 mass % or more.

The ratio of the crosslinked aromatic polyamide in the separation functional layer of the composite semipermeable membrane can be calculated by nuclear magnetic resonance measurement (hereinafter referred to as “NMR measurement”). For example, the substrate is physically peeled off from the composite semipermeable membrane to obtain the microporous support layer and the separation functional layer. The collected microporous support layer and separation functional layer are allowed to stand at 25 °C for 24 hours and dried, and then added little by little to a beaker containing dichloromethane and stirred to dissolve a polymer that constitutes the microporous support layer. A work of collecting an insoluble matter in the beaker using a filter paper, placing the obtained insoluble matter in the beaker containing dichloromethane and stirring, and collecting the insoluble matter in the beaker is repeated until no elution of the polymer forming the microporous support layer can be detected in the dichloromethane solution. The collected insoluble matter is dried in a vacuum dryer to remove the remaining dichloromethane, and the obtained insoluble matter is isolated as a powdered sample by freeze-pulverization. This powdered sample, that is, the separation functional layer, is immersed in a high-concentration, high-temperature sodium hydroxide aqueous solution until solids dissolve, thereby subjecting the separation functional layer to alkaline hydrolysis, and the obtained solution is subjected to ¹H-NMR measurement, allowing a monomer to be quantified from an obtained area of a peak. A mass basis ratio of the monomer having an aromatic ring corresponds to a mass basis ratio of the crosslinked aromatic polyamide.

Examples of the crosslinked aromatic polyamide include aramid-based compounds, and a molecular structure of the aramid-based compounds may contain a site other than an aromatic site. Among these, from the viewpoints of rigidity, chemical stability, and/or durability against an operating pressure, crosslinked wholly aromatic polyamides are more preferable. The crosslinked aromatic polyamide can be formed by interfacial polycondensation between a polyfunctional aromatic amine and a poly functional aromatic acid halide. Here, in order to form a crosslinked structure, at least one of the polyfunctional aromatic amine and the polyfunctional aromatic acid halide contains a trifunctional or higher functional compound.

The “polyfunctional aromatic amine” means an aromatic amine having two or more amino groups of at least one of a primary amino group and a secondary amino group in one molecule, and at least one of the amino groups is a primary amino group.

Examples of the polyfunctional aromatic amine include polyfunctional aromatic amines in which two amino groups are bonded to an aromatic ring in any positional relationship of an ortho position, a meta position, and a para position, such as o-phenylenediamine, m-phenylenediamine (hereinafter referred to as “m-PDA”), p-phenylenediamine, o-xylylenediamine, m-xylylenediamine, p-xylylenediamine, o-diaminopyridine, m-diaminopyridine, and p-diaminopyridine; and polyfunctional aromatic amines such as 1,3,5-triaminobenzene, 1,2,4-triaminobenzene, 3,5-diaminobenzoic acid, 3-aminobenzylamine, and 4-aminobenzylamine.

Among these, m-PDA, p-phenylenediamine or 1,3,5-triaminobenzene is preferably used from the viewpoint of improving selective separability, permeability, and heat resistance of the membrane. Among these, m-PDA is more preferably used because of ease of availability and handling. These polyfunctional aromatic amines may be used alone or in combination of two or more thereof.

The “polyfunctional aromatic acid halide” refers to an aromatic acid halide having at least two halogenated carbonyl groups in one molecule. Examples of a trifunctional acid halide include a trimesic acid chloride, and examples of a bifunctional acid halide include biphenyl dicarboxylic acid dichloride, azo benzene dicarboxylic acid dichloride, terephthalic acid chloride, isophthalic acid chloride, and naphthalene dicarboxylic acid chloride. Among these acid halides, acid chlorides are preferred, and trimesic acid chloride (hereinafter referred to as “TMC”), which is an acid halide of 1,3,5-benzene tricarboxylic acid, is particularly preferred from the viewpoints of economy, ease of availability, ease of handling, ease of reactivity, and the like.

In consideration of reactivity with the polyfunctional aromatic amine, the polyfunctional aromatic acid halide is preferably a polyfunctional aromatic acid chloride. In addition, from the viewpoints of improving selective separability and heat resistance of the membrane, it is more preferable to use a polyfunctional aromatic acid chloride having 2 to 4 carbonyl chloride groups in one molecule.

Examples of the crosslinked aromatic polyamide include polyamides that are polymers of trimesic acid chloride and m-phenylenediamine.

### <Thin Film>

The separation functional layer in the composite semipermeable membrane according to the present embodiment is formed of a thin film. The above description for the composition of the separation functional layer also applies to the thin film. That is, in the above description, the “separation functional layer” may be read as the “thin film”.

The shape and thickness of the thin film influence the separation performance and permeability. As shown in FIG. 2, the thin film constitutes a fold structure in which a plurality of protrusions repeatedly appear. FIG. 2 is a schematic view showing a structure of protrusions formed of a thin film in a cross section perpendicular to the membrane surface direction of the composite semipermeable membrane.

FIG. 3 is a schematic view showing the structure of the protrusion formed of the thin film in the cross section perpendicular to the membrane surface direction of the composite semipermeable membrane, and is a view showing the protrusion in an enlarged manner as compared with FIG. 2.

The protrusion is a structure constituted by a thin film 5 of the separation functional layer, and refers to a space (convex portion 6) between apexes of two portions (which may also be called concave portions) of the thin film 5 that are adjacent to each other in the x direction and are convex toward the microporous support layer 3 (FIG. 3). FIG. 3 shows an example in which one of both ends (apexes of the concave portions) of the protrusion (convex portion 6) is separated from a surface of the microporous support layer 3 and the other is in contact with the surface of the microporous support layer 3. The both ends of the protrusion may be in contact with the microporous support layer 3, or both ends may be separated from the microporous support layer 3.

As shown in FIG. 4, the “apparent height of the protrusion” is a height of the protrusion (convex portion 6) based on the surface of the microporous support layer 3, that is, a distance from the surface of the microporous support layer 3 to an apex of the protrusion (convex portion 6). In an apparent height Pah of the protrusion, a position of the surface of the microporous support layer 3 in the y-axis direction passing through the apex of the protrusion (convex portion 6) is 0% of the height, and the apex of the protrusion (convex portion 6) is 100% of the height. The “apex of the protrusion” in the “apparent height of the protrusion” means a position farthest from the microporous support layer in the protrusion.

Ten-point average surface roughness used for measuring the thickness of the thin film or the like is described below.

An image of a cross section of the composite semipermeable membrane perpendicular to the membrane surface direction and having a length of 2.0 μm in the membrane surface direction is obtained by the following procedure.

A sample section having a cross section perpendicular to the membrane surface direction of the composite semipermeable membrane can be obtained by a freezing superthin section method. Further, cross-sectional observation can be performed by an electron microscope such as a scanning electron microscope (SEM, FE-SEM), a transmission electron microscope (TEM), or a scanning transmission electron microscopy (STEM). An observation magnification is preferably 10,000 to 100,000 times. In the obtained cross-sectional image, a surface of the thin film 5 in the separation functional layer appears as a curve, as shown in FIG. 2. For this curve, a roughness curve defined based on JIS B 0601 (ISO 4287:1997) is obtained. A cross-sectional image is taken from the cross section of the sample section in a direction of an average line A of the roughness curve (hereinafter also referred to as the “average line A”) with a width of a reference length L (2.0 μm).

The “average line” is defined based on JIS B 0601 (ISO 4287:1997) and is a straight line drawn such that total areas of regions surrounded by the average line and the roughness curve above and below the average line are equal in a measurement range.

In the cross-sectional image taken in this manner, a sum of a mean value of absolute values of elevations of the highest to fifth peaks from the average line A (elevations Yp1 to Yp5 of the highest to fifth peaks from the average line A) on the roughness curve and a mean value of absolute values of elevations of the lowest to fifth valleys (elevations Yv1 to Yv5 of the lowest to fifth valleys from the average line A) is calculated, and this value expressed in nanometers (nm) is the ten-point average surface roughness in the cross-sectional image (FIG. 2).

The same measurement is performed on 10 randomly selected cross-sectional images, and the mean value of the obtained ten-point average surface roughness is defined as the ten-point average surface roughness of the composite semipermeable membrane.

The “height of the protrusion” can be calculated as follows. In a cross-sectional image having a width of 2.0 μm extracted from 10 cross-sectional images randomly selected as described above, for protrusions in which the apparent height Pah is one-fifth or more of the above-mentioned ten-point average surface roughness, distances d1 and d2 between both ends of the protrusion in the membrane surface direction of the composite semipermeable membrane and the average line A are measured. A mean value d of the distances d1 and d2 is calculated.

Here, the distances d1 and d2 are distances from the average line A to the both ends of the protrusion in a direction perpendicular to the membrane surface direction of the composite semipermeable membrane. The both ends of the protrusion refer to apexes of two adjacent portions of the thin film that are convex toward the microporous support layer. In other words, the both ends of the protrusion are the apexes of the two concave portions that sandwich the protrusion.

That is, as shown in FIG. 3, a sum of a depth at the both ends of the protrusion (convex portion 6), that is, average d of the distance d1 from the average line A to the apex of the concave portion on a left side of the protrusion and the distance d2 from the average line A to the apex of the concave portion on a right side of the protrusion, and a distance h from the average line A to the apex of the protrusion is calculated as a height Ph of the protrusion. In the direction perpendicular to the membrane surface direction of the composite semipermeable membrane, a position where a distance from the average line A toward the microporous support layer is d is the height 0%, and the apex of the protrusion is the height 100%. The “apex of the protrusion” in the “height of the protrusion” refers to a position within the protrusion that is farthest from the average line of the roughness curve described above.

The height of the protrusion is preferably 70 nm or more, and more preferably 90 nm or more, from the viewpoint of ensuring sufficient water permeability of the composite semipermeable membrane. In addition, from the viewpoint of preventing deformation of the protrusion at the time of high-pressure operation and obtaining stable membrane performance, the height of the protrusion is preferably 1000 nm or less, more preferably 800 nm or less, and still more preferably 400 nm or less. That is, the height of the protrusion is preferably 70 nm to 1000 nm. The height of the protrusion can be adjusted, for example, by changing a concentration of the polyfunctional aromatic amine in the polyfunctional aromatic amine aqueous solution or a temperature at which the microporous support layer brought into contact with the polyfunctional aromatic amine aqueous solution is brought into contact with the organic solvent solution of the polyfunctional aromatic acid halide.

The thickness of the thin film means the shortest distance from a certain point on a surface of the thin film to a surface on the opposite side. The thickness of the thin film can be measured by photographing a cross section of the protrusion perpendicular to the membrane surface direction of the composite semipermeable membrane with a transmission electron microscope (TEM) and reading a cross-sectional image into image analysis software for analysis. An observation magnification may be appropriately determined depending on the thickness of the thin film. For example, in order to observe a cross-sectional shape of the thin film and to avoid localized measurement, if the thickness of the thin film is about 10 nm to 100 nm, the observation magnification may be set to 50,000 to 100,000 times. The protrusions to be measured for the thin film thickness are selected at random from protrusions having a height equal to or greater than one-fifth of the ten-point average surface roughness.

The thickness of the thin film constituting the protrusion and a ratio (T98/T25) of an average thickness T98 of the thin film in a range of 75% to 98% of the height of the protrusion to an average thickness T25 of the thin film in a range of 2% to 25% of the height of the protrusion can be calculated as follows.

Here, the range of 75% to 98% of the height of the protrusion is also referred to as an “upper portion of the protrusion”, and the range of 2% to 25% of the height of the protrusion is also referred to as a “lower portion of the protrusion”.

As shown in FIG. 3, the mean value d of the depths d1 and d2 of the concave portions on both sides of the protrusion (convex portion 6) in the x-axis direction is calculated. A position Z below the average line A (microporous support layer 3 side) and at a distance d from the average line A in the y-axis direction is set to 0% height, and a position B of the apex of the protrusion is set to 100% height. The thickness of the thin film constituting the protrusion is measured at 10 random locations on each of the upper portion of the protrusion and the lower portion of the protrusion. The same measurement is carried out for five protrusions in which a height is at one-fifth or more of the ten-point average surface roughness. An arithmetic mean value is calculated for the thin film thickness at 50 points in the lower portion of the protrusion. This value is defined as the average thickness T25 of the lower portion of the protrusion formed by the thin film in the composite semipermeable membrane. An arithmetic mean is also calculated for the thin film thickness in a region of the upper portion of the protrusion in the same manner, and this is taken as the average thickness T98 of the upper portion of the protrusion formed by the thin film. From the viewpoint of improving the durability of the protrusion against external physical forces and preventing deformation to maintain water permeability and a salt removal rate, and ensuring good water permeability, the average thickness T25 of the lower portion of the protrusion is preferably 13 nm to 24 nm. The thickness of the thin film that constitutes the protrusion can be adjusted by the temperature at which the microporous support layer brought into contact with the polyfunctional aromatic amine aqueous solution is brought into contact with the organic solvent solution of the polyfunctional aromatic acid halide, a heating temperature, or by a step of bringing a solution containing a compound containing an amide group into contact with a layer containing a crosslinked aromatic polyamide to be described below.

The ratio (T98/T25) of the average thickness T98 of the upper portion of the protrusion to the average thickness T25 of the lower portion of the protrusion is preferably 0.95 or less, and more preferably 0.70 to 0.92. The composite semipermeable membrane is generally used in a stacked manner, and a flow channel member is inserted between the membranes. When T98/T25 satisfies this range, the thin film is thin and flexible at the upper portion of the protrusion and thick and strong at the lower portion of the protrusion. Therefore, even if the protrusion rub against the flow channel member or other composite semipermeable membranes during use, force is dispersed to the lower portion of the protrusion, reducing damage and enabling the salt removal rate to be maintained.

The separation functional layer contains an amide group derived from the polymerization of the polyfunctional aromatic amine and the polyfunctional aromatic acid halide, and an amino group and a carboxy group derived from an unreacted functional group, and the protrusion contains many oxygen atoms (hereinafter referred to as “O”) and nitrogen atoms (hereinafter referred to as “N”). A ratio (O/N ratio) of oxygen atoms to nitrogen atoms in the protrusion is obtained by analysis using electron energy-loss spectroscopy (EELS) during TEM observation. The present inventors have found that, for the protrusions having the apparent height Pah of one-fifth or more of the above-mentioned ten-point average surface roughness, when a mean value of O/N ratios in the range of 2% to 25% of the apparent height of the protrusion is x and a mean value of O/N ratios in the range of 75% to 98% of the apparent height of the protrusion is y, a composite semipermeable membrane that satisfies y/x≥1.3 has particularly high water permeability and removability, and further exhibits high removability even after contact with chlorine. x and y can be adjusted by a monomer concentration of the polyfunctional aromatic amine or the polyfunctional aromatic acid halide, an additive that may be used in the interfacial polycondensation, or by introducing a step of bringing the solution containing the compound containing the amide group into contact with the layer containing the crosslinked aromatic polyamide described below.

The O/N ratio in a main skeleton repeating unit of the crosslinked aromatic polyamide is the same at both of the top and bottom of the protrusion, and therefore the O/N ratio in the protrusion is substantially proportional to (carboxy group present at a terminal of the crosslinked aromatic polyamide)/(amino group present at the terminal of the crosslinked aromatic polyamide). The terminal functional group also affects the removing performance and water permeability of the composite semipermeable membrane. In a region in which amino group density is high, the separation functional layer has a sparse structure, and water permeation resistance is lower, and thus water permeability is high, but solute removing performance is insufficient. On the other hand, in a region in which amino group density is low, the separation functional layer has a dense structure, and water permeation resistance is high, and thus water permeability is lower, but the solute removing performance is improved. By providing an O/N ratio gradient structure within the protrusion and creating small pore diameter portions and highly charged portions, it is possible to achieve both particularly high water permeability and removing performance. Here, the O/N ratio gradient structure refers to a structure in which the O/N ratios differ between the top and the bottom of the protrusion, and the O/N ratio is higher at the top of the protrusion than at the bottom thereof. Further, amino groups are generally easily oxidized by oxidizing agents such as chlorine and hypochlorous acid. Therefore, when there are a large number of amino groups, the removability after contact with chlorine is likely to decrease due to a structural change caused by oxidation. A portion within the range of 75% to 98% of the apparent height of the protrusion is more easily accessible to chlorine than a portion within the range of 2% to 25% of the apparent height of the protrusion, and is therefore particularly susceptible to effects of oxidative deterioration caused by chlorine. Taking these factors into consideration, the inventors have found that by increasing the O/N ratio in the range of 75% to 98% of the apparent height of the protrusion, to which chlorine can be easily accessible, and forming the protrusion that satisfy y/x≥1.3, it is possible to maintain the removing performance and water permeability of the composite semipermeable membrane and improve chlorine resistance. The value of y/x is preferably y/x≥1.6, and more preferably y/x≥2.0.

In the composite semipermeable membrane according to the present embodiment, the protrusion preferably satisfies y≥0.90 and more preferably satisfies y≥1.2 from the viewpoint of improving the salt removability by an electrostatic field formed by a charge and improving the water permeability by the hydrophilicity of the carboxy group by containing sufficient carboxy groups in the portion in the range of 75% to 98% of the apparent height of the protrusion to which the raw water is most accessible. On the other hand, from the viewpoint of preventing blocking of pores constituted by the crosslinked aromatic polyamide due to strong hydrogen bonds between carboxy groups within or between molecules of the crosslinked aromatic polyamide, it is preferable that y≤2.0. That is, 0.90≤y≤2.0 is preferable.

x, which is the mean value of the O/N ratios in the range of 2% to 25% of the apparent height of the protrusion, and y, which is the mean value of the O/N ratios in the range of 75% to 98% of the apparent height of the protrusion, can be calculated by the method described below in “(v) Measurement of O/N Ratio of protrusion”. At this time, a position of the surface of the microporous support layer when determining the apparent height of the protrusion can be a position at which elements contained only in the microporous support membrane are no longer detected when the protrusion is measured by TEM-EELS.

In the composite semipermeable membrane according to the present embodiment, the protrusion preferably satisfies x≥0.50 from the viewpoint of easily achieving both the water permeability and the removing performance by appropriately setting the amino group density. Further, although a contribution is small compared to the portion in 75% to 98% of the apparent height of the protrusion, by satisfying x≥0.50, it is possible to prevent the oxidative deterioration that occurs when the oxidizing agent reaches a base portion of the protrusion. On the other hand, from the viewpoint of preventing the blocking of the pores constituted by the crosslinked aromatic polyamide due to the strong hydrogen bonds between the carboxy groups within or between the molecules of the crosslinked aromatic polyamide, it is preferable that x≤2.0. That is, 0.50≤x≤2.0 is preferable.

As for a number density of the protrusions in the composite semipermeable membrane according to the present embodiment, from the viewpoint of preventing deformation of the protrusions when a pressure is applied and obtaining stable performance, average number density of the protrusions is preferably 13.0 protrusions/μm or more, and more preferably 15.0 protrusions/μm or more. Further, from the viewpoint of allowing the protrusion to grow sufficiently and easily obtaining a composite semipermeable membrane having desired water permeability, the average number density of the protrusions is preferably 50.0 protrusions/μm or less, and more preferably 40.0 protrusions/μm or less. That is, the average number density of the protrusions is preferably 13.0 protrusions/μm to 50.0 protrusions/μm. The average number density of the protrusions can be adjusted by changing the material of the microporous support layer, changing the concentration of the material used for the microporous support layer, for example, changing a PSf concentration, and a time or a temperature of the interfacial polycondensation.

The average number density of protrusions can be calculated by counting the number of protrusions having a height equal to or greater than one-fifth of the ten-point average surface roughness in the cross-sectional image having the length of 2.0 μm in the membrane surface direction taken from a cross-sectional image perpendicular to the membrane surface direction of a randomly selected composite semipermeable membrane. Similar measurements are carried out on cross-sectional images perpendicular to the membrane surface direction of 10 randomly selected composite semipermeable membranes, and a mean value of the obtained values is regarded as the average number density of protrusions.

In order to prevent a substance to be separated from penetrating into the composite semipermeable membrane, the separation functional layer is preferably disposed on a surface side of the composite semipermeable membrane, and more preferably disposed on a primary filtration side.

### 2. Method for Producing Composite Semipermeable Membrane

A method for producing a composite semipermeable membrane according to the present embodiment is not particularly limited as long as a composite semipermeable membrane that satisfies the above-described desired characteristics can be obtained, and the composite semipermeable membrane can be produced, for example, by the following method.

For example, the method for producing a composite semipermeable membrane including a microporous support layer and a separation functional layer provided on the microporous support layer includes:
a step of forming a layer containing a crosslinked aromatic polyamide on the microporous support layer by interfacial polycondensation using a polyfunctional aromatic amine aqueous solution and an organic solvent solution of a polyfunctional aromatic acid halide; and
a step of bringing a solution containing a compound containing an amide group into contact with the layer containing the crosslinked aromatic polyamide.

### (2-1) Formation of Support Membrane

As a method for forming a support membrane, a known method can be suitably used. Hereinafter, a case where PSf is used as the material of the microporous support layer will be described as an example.

First, PSf is dissolved in a good solvent of PSf to prepare a microporous support layer raw solution. As the good solvent of PSf, for example, N,N-dimethylformamide (hereinafter, referred to as “DMF”) is preferable.

A concentration of PSf in the microporous support layer raw solution is preferably 12 mass % to 25 mass %, and more preferably 14 mass % to 23 mass %. As a polymer concentration (that is, solid content concentration) of a polymer solution is higher, a microporous support layer having higher number density of particles on the surface of the microporous support layer is obtained, and as a result, the number density of the protrusions in the separation functional layer also increases, and the water permeability is improved. In addition, since the polymer concentration is low to such an extent that a monomer supply rate at the time of forming the separation functional layer is not too low, a surface fine pore diameter of the microporous support layer is adjusted, and a protrusion having an appropriate height and/or apparent height is formed at the time of forming the separation functional layer. When the concentration of PSf in the microporous support layer raw solution is within this range, it is possible to achieve both the strength and the permeability of the obtained microporous support layer. A preferable range of the concentration of the material in the microporous support layer raw solution can be appropriately adjusted according to the material to be used, the good solvent, and the like.

Next, the obtained microporous support layer raw solution is applied to a surface of the substrate, and is immersed in a coagulation bath containing a non-solvent of PSf.

The non-solvent of PSf contained in the coagulation bath is preferably water, for example. By bringing the microporous support layer raw solution applied on the surface of the substrate into contact with the coagulation bath containing the non-solvent of PSf, the microporous support layer raw solution is solidified by the non-solvent induced phase separation, and a support membrane in which a microporous support layer is formed on the surface of the substrate can be obtained.

The coagulation bath may be composed of only the non-solvent of PSf, or may contain the good solvent of PSf in a range in which the microporous support layer raw solution can be coagulated.

The solvent remaining in the membrane may be removed by washing the obtained support membrane before the formation of the separation functional layer.

### (2-2) Polymerization Step of Separation Functional Layer

As a method for forming the separation functional layer containing the crosslinked aromatic polyamide, a method for polymerizing and solidifying a polyfunctional aromatic amine and a polyfunctional aromatic acid chloride on the support membrane obtained by “(2-1) Formation of Support Membrane” will be described as an example. In the polymerization method, from the viewpoint of productivity and performance, an interfacial poly condensation method is most preferable. An interfacial polycondensation step is described below.

The interfacial polycondensation step preferably includes (a) a step of bringing an aqueous solution containing a polyfunctional aromatic amine into contact with a support membrane; (b) a step of bringing an organic solvent solution containing a polyfunctional aromatic acid chloride into contact with the support membrane brought into contact with the aqueous solution containing the polyfunctional aromatic amine and heating the obtained support membrane; (c) a step of removing the organic solvent solution after the contact; (d) a step of bringing a separation functional layer generated by interfacial polycondensation into contact with a solution A containing a compound containing an amide group; and (e) a step of washing the composite semipermeable membrane with hot water.

Examples of the microporous support layer, the polyfunctional aromatic amine, and the polyfunctional aromatic acid halide include those described above, and preferred examples thereof are also the same.

In step (a), a concentration of the polyfunctional aromatic amine in the polyfunctional aromatic amine aqueous solution is preferably in a range of 0.1 mass % to 20 mass %, and more preferably in a range of 0.5 mass % to 15 mass %. When the concentration of the polyfunctional aromatic amine falls within this range, the composite semipermeable membrane after the production can have sufficient solute removing performance and water permeability. Two or more kinds of polyfunctional aromatic amines may be used.

The polyfunctional aromatic amine aqueous solution may contain a surfactant, an organic solvent, an alkaline compound, an antioxidant, or the like, as long as it does not interfere with the reaction between the polyfunctional aromatic amine and the polyfunctional aromatic acid halide. The surfactant has an effect of improving wettability of the support membrane surface and reducing an interfacial tension between the polyfunctional aromatic amine aqueous solution and a nonpolar solvent. The organic solvent sometimes acts as a catalyst for the interfacial polycondensation reaction, and the interfacial polycondensation reaction may efficiently be performed owing to addition of the organic solvent.

In step (a), the polyfunctional aromatic amine aqueous solution is preferably uniformly and continuously brought into contact with the support membrane. Specific examples thereof include a method for coating a support membrane with a polyfunctional aromatic amine aqueous solution, and a method for immersing a support membrane in a polyfunctional aromatic amine aqueous solution. A contact time between the support membrane and the polyfunctional aromatic amine aqueous solution is preferably 1 second to 10 minutes, and more preferably 3 seconds to 3 minutes.

After the polyfunctional aromatic amine aqueous solution is brought into contact with the support membrane, it is preferable to sufficiently remove liquid such that no droplet remains on the support membrane. By sufficiently removing liquid, it is possible to prevent droplet residue from becoming a membrane defect after composite semipermeable membrane formation and deteriorating separation performance. Examples of a liquid removal method include, as disclosed in JPH02-78428A, a method for holding the support membrane in a vertical direction after the contact with the poly functional aromatic amine aqueous solution and allowing the excessive aqueous solution to naturally flow down, or a method for forcibly removing liquid by blowing an air flow such as nitrogen from an air nozzle. In addition, after the liquid removal, the membrane surface may be dried to partially remove water of the polyfunctional aromatic amine aqueous solution.

Examples of the polyfunctional aromatic acid chloride in step (b) include TMC, biphenyl dicarboxylic acid dichloride, azo benzene dicarboxylic acid dichloride, terephthalic acid chloride, isophthalic acid chloride, naphthalene dicarboxylic acid chloride, and 2,5-furan dicarboxylic acid chloride. These polyfunctional aromatic acid chlorides may be used alone or in combination of two or more thereof.

The organic solvent is preferably immiscible with water, dissolves the polyfunctional aromatic acid chloride, does not erode the support membrane, and is inactive to the polyfunctional aromatic amine and the polyfunctional aromatic acid chloride. Examples of the organic solvent include hydrocarbon compounds such as n-nonane, n-decane, n-undecane, n-dodecane, isooctane, isodecane, and isododecane, and mixed solvents thereof.

A concentration of the polyfunctional aromatic acid chloride in the organic solvent solution is preferably 0.01 mass % to 10 mass %, more preferably 0.02 mass % to 4 mass %, and still more preferably 0.03 mass % to 2 mass %. When the concentration of the polyfunctional aromatic acid chloride is 0.01 mass % or more, the polymerization can proceed at a sufficient reaction rate. On the other hand, when the concentration of the polyfunctional aromatic acid chloride is 10 mass % or less, a side reaction during polymerization can be prevented. The organic solvent solution may contain a compound such as a surfactant as necessary as long as the polymerization is not inhibited.

The method for bringing the organic solvent solution of the polyfunctional aromatic acid chloride into contact with the support membrane brought into contact with the polyfunctional aromatic amine aqueous solution may be the same as the method for bringing the support membrane into contact with the polyfunctional aromatic amine aqueous solution in step (a). By bringing the support membrane brought into contact with the polyfunctional aromatic amine aqueous solution into contact with the polyfunctional aromatic acid chloride solution, the separation functional layer begins to form.

A temperature at which the microporous support layer which has been brought into contact with the aqueous solution containing the polyfunctional aromatic amine is brought into contact with a solution in which the polyfunctional aromatic acid halide is dissolved is preferably 25 °C to 60 °C, and more preferably 30 °C to 55 °C. By setting the temperature at 25 °C or higher, the height and/or apparent height of the protrusion becomes sufficient. Further, by setting the temperature at 60 °C or less, the reaction rate becomes appropriate, and an increase in the thickness of the thin film and the progress of the coalescence of the protrusions are prevented, so that sufficient water permeability is easily obtained in the produced composite semipermeable membrane. In addition, an amount of amine supplied from the support membrane to the interfacial polycondensation field is initially appropriate, the amount of amino groups in the range of 2% to 25% of the apparent height of the protrusion is prevented, and x≥0.50 is more easily satisfied. When the contact temperature is 25 °C to 60 °C, the number of protrusions increases and a surface area of a reaction interface substantially increases, so that an amount of polyamide increases and an increase in the average thicknesses T25 and T98 of the protrusion can be prevented. As a method for imparting the temperature, the support membrane may be heated, or a heated organic solvent solution of the polyfunctional aromatic acid halide may be brought into contact. The temperature of the membrane surface immediately after the polyfunctional aromatic amine aqueous solution is brought into contact with the polyfunctional aromatic acid halide solution can be measured with a non-contact thermometer such as a radiation thermometer.

After the separation functional layer is formed by contacting with the organic solvent solution of the polyfunctional aromatic acid chloride, the separation functional layer and the support membrane may be heat-treated. In the case of heat treatment, a heating temperature is preferably 50 °C to 180 °C, more preferably 60 °C to 160 °C, still more preferably 80 °C to 150 °C. By setting the heating temperature within the above range, coalescence of the protrusions is prevented, the number density of the protrusions becomes appropriate, and the average thickness of the protrusions is prevented from becoming too thick, making it easier to obtain good water permeability.

In step (c), the organic solvent is removed from the support membrane and the separation functional layer by a step of removing the organic solvent solution after the reaction. The removal of the organic solvent can use, for example, a method of holding the membrane in a vertical direction to remove an excess organic solvent by allowing the excess organic solvent to naturally flow down, a method of drying and removing an organic solvent by blowing air with a blower, or a method of removing an excess organic solvent with a mixed fluid of water and air.

In step (d), the functional layer produced by the interfacial polycondensation is brought into contact with the solution A containing the compound containing the amide group. Examples of the compound containing the amide group include a chain amide compound and a cyclic amide compound. Examples of the chain amide compound include N-methylformamide, N,N-dimethylformamide, N,N-dimethylacetamide, N,N-diethylformamide, N,N-diisopropylformamide, N,N-dibutylformamide, N,N-diethylacetamide, tetramethylurea, tetraethylurea, and N,N-diethyldodecanamide. Examples of the cyclic amide compound include N-methylpyrrolidinone, γ-butyrolactam, ε-caprolactam, 1,3-dimethyl-2-imidazolidinone, and N,N′-dimethylpropyleneurea.

In the separation functional layer immediately after step (c), polyamides having a polyfunctional aromatic acid chloride terminal, a carboxy terminal resulting from hydrolysis of an acid chloride terminal, a polyfunctional aromatic amino group terminal, oligomers, and unreacted monomers are present. By contacting with the solution A containing the compound having the amide group, the amide group in the solution A interacts with the amino group present in the separation functional layer through hydrogen bonding, making it easier to remove the oligomers having an amino group and the unreacted monomers from the separation functional layer, and thereby reducing the number of nitrogen atoms (N) contained in the separation functional layer. In addition, since the compound having the amide group acts on the acid chloride terminal and promotes the hydrolysis, so that the amount of carboxy groups contained in the separation functional layer increases, and the number of oxygen atoms (O) also increases. The portion in the range of 75% to 98% of the apparent height of the protrusion of the separation functional layer has smaller steric hindrance than the portion in the range of 2% to 25%, and therefore the compound having the amide group can easily approach the portion, and an effect caused by the above-mentioned action is large. Therefore, The protrusion in the separation functional layer have a large y, which is the mean value of the O/N ratios in the range of 75% to 98% of the apparent height of the protrusion, and are more likely to satisfy y≥0.90 and y/x≥1.3. Further, the hydrolysis of the acid chloride terminal is promoted and the oligomers having the amino group and the unreacted monomers are removed, so that in the polymerization reaction in the range of 75% to 98% of the height of the protrusion, a termination reaction proceeds faster than in the polymerization reaction in the range of 2% to 25% of the height of the protrusion, so that T98/T25 tends to satisfy 0.95 or less.

The concentration of the compound containing the amide group in the solution A is preferably from 0.1 mass % to 40 mass %, and more preferably from 1.0 mass % to 30 mass %. When the concentration is 0.1 mass % or more, the above-mentioned effect can be sufficiently obtained. In addition, by setting the concentration to 40 mass % or less, even if the compound containing the amide group is the good solvent for PSf that forms the support membrane, it is unlikely to invade the separation functional layer or the support membrane, and a decrease in the removal rate can be prevented. A time for bringing the separation functional layer into contact with the solution A is preferably within 5 minutes, and more preferably within 2 minutes. By setting the contact time to 5 minutes or less, the action on the portion in the range of 2% to 25% of the apparent height of the protrusion is prevented, making it easier to satisfy y/x≥1.3. A temperature of the solution A in contact with the separation functional layer is preferably 0 °C to 50 °C, and more preferably 5 °C to 40 °C. By the contact is performed at a temperature of 50 °C or less, an increase in mobility of a polyamide chain is prevented, and the action on the portion in the range of 2% to 25% of the apparent height of the protrusion is prevented, making it easier to satisfy, y/x≥1.3. As a method for the contact, a method for coating the surface of the composite semipermeable membrane with the solution A or a method for immersing the composite semipermeable membrane in the solution A can be mentioned.

In step (e), the composite semipermeable membrane is washed with hot water. A temperature of the hot water is preferably 40 °C to 95 °C, and more preferably 60 °C to 95 °C. When the temperature of the hot water is 40 °C or more, unreacted substances and oligomers remaining in the membrane can be sufficiently removed. On the other hand, when the temperature of the hot water is 95 °C or less, a shrinkage degree of the composite semipermeable membrane does not increase, and good permeability can be maintained. A preferred range of the temperature of the hot water can be appropriately adjusted according to the polyfunctional aromatic amine or the polyfunctional aromatic acid chloride to be used.

It is possible to improve the performance of the composite semipermeable membrane by introducing a new functional group by a modification treatment caused by a chemical reaction in which an amino group present in the crosslinked aromatic polyamide is appropriately selected.

Examples of the new functional group include an alkyl group, an alkenyl group, an alkynyl group, a halogeno group, a hydroxyl group, an ether group, a thioether group, an ester group, an aldehyde group, a nitro group, a nitroso group, a nitrile group, and an azo group.

### 3. Use of Composite Semipermeable Membrane

The composite semipermeable membrane is wound around a tubular water collection pipe, in which a large number of holes are bored, together with a supply water channel material such as a plastic net, a permeated water channel material such as a tricot, and a film for increasing pressure resistance as necessary, to be suitably used as a spiral type composite semipermeable membrane element. Furthermore, a composite semipermeable membrane module in which these elements are connected in series or in parallel and accommodated in a pressure vessel can also be provided.

The composite semipermeable membrane, and the element and the module thereof described above can be combined with a pump that supplies supply water thereto, a device that pretreats the supply water, and the like to constitute a fluid separation device. By using this separation device, the supply water can be separated into permeated water, such as drinking water, and concentrated water, which does not permeate the membrane, to obtain intended water.

Examples of the supply water to be treated by the above composite semipermeable membrane include a liquid mixture containing 500 mg/L or more and 100 g/L or less of total dissolved solids (hereinafter referred to as “TDS”) such as seawater, brackish water, and wastewater. Generally, TDS refers to an amount of total dissolved solids content and is represented by “mass÷volume (value obtained by dividing mass by volume)” or “mass ratio”. According to the definition, the TDS can be calculated based on a weight of a residue obtained by evaporating, at a temperature of 39.5 °C or higher and 40.5 °C or lower, a solution filtrated through a 0.45 μm filter, and is more conveniently converted from practical salinity (S).

In consideration that, as the operating pressure of the fluid separation device increases, a solute removal rate increases but energy required for the operation also increases, and in consideration of durability of the composite semipermeable membrane, the operating pressure when water to be treated permeates the composite semipermeable membrane is preferably 0.5 MPa or more and 10 MPa or less. At this time, the greater the amount of water permeated through the membrane, the lower the operating pressure required to obtain the same amount of permeated water, which is preferable because this results in energy savings. For a sufficiently energy-saving operation, an initial membrane permeation flux before contact with chlorine is preferably 0.95 m³/m²/d or more, and more preferably 1.0 m³/m²/d or more. Further, the higher the solute removing performance of the membrane, the more the water quality can be ensured even if the operating pressure is reduced. In order to ensure sufficient water quality, the initial salt removal rate before contact with chlorine is preferably 99.75% or more. Furthermore, in order to withstand practical use even when chlorine which has leaked due to an operation error is brought into contact with the membrane, it is preferable that a salt penetration ratio (SP ratio) before and after a chlorine resistance test described in Examples is 2.00 or less. The temperature of the supply water is preferably 5 °C or higher and 45 °C or lower since the solute removal rate decreases as the temperature increases and a membrane permeation flux decreases as the temperature decreases. In the case of supply water having a high solute concentration such as seawater, when the pH of the supply water is increased, there is a concern that scale of magnesium or the like is generated, and there is a concern that the membrane is deteriorated due to a high pH operation, and thus an operation in a neutral region is preferred.

### EXAMPLES

Hereinafter, the present invention will be described with reference to specific examples, but the present invention is not limited to these examples.

The performance evaluation of the composite semipermeable membrane obtained below was conducted as follows.

### (i) Measurement of Salt Removal Rate

A circular membrane having a diameter of 75 mm was cut out and set in a membrane evaluation cell. Seawater having a TDS concentration of 3.5% and adjusted to a temperature of 25 °C and a pH of 6.5 was supplied at an operating pressure of 5.5 MPa, and the permeated water was collected after stabilization after operation for 3 hours. The TDS concentration of the obtained permeated water was determined from electric conductivity, and the salt removal rate was calculated according to the following Formula (1).

Salt removal rate (%)=100×{1−(TDS concentration in permeated water/TDS concentration in supply water)} Formula (1)

A value rounded to the third decimal place was used.

### (ii) Measurement of Membrane Permeation Flux

The membrane permeation flux (m³/m²/d) was calculated from a water permeation amount (m³) per square meter of the membrane surface per day obtained under the conditions described in the above “(i) Measurement of Salt Removal Rate”.

(iii) Chlorine Deterioration Test

The composite semipermeable membrane was immersed in a 100 mg/L sodium hypochlorite aqueous solution adjusted to pH of 7.0 at 25 °C for 24 hours. Subsequently, the composite semipermeable membrane was immersed in a 1000 mg/L sodium hydrogen sulfite aqueous solution for 10 minutes and then thoroughly washed with water to obtain a composite semipermeable membrane after a chlorine deterioration test. The chlorine resistance was determined from a salt penetration ratio (SP ratio) before and after the immersion.

SP ratio=(100−salt removal rate after immersion)/(100−salt removal rate before immersion)} Formula (2)

Generally, the salt removal rate of the composite semipermeable membrane decreases when the composite semipermeable membrane is immersed in chlorine. This means that as the SP ratio is greater than 1.00, the salt removal rate of the composite semipermeable membrane decreases.

### (iv) Measurement of Average Thickness of Protrusion and Average Number Density of Protrusions

The composite semipermeable membrane was cut into a corner of 3 cm×3 cm and washed with distilled water at 25 °C for 24 hours. The composite semipermeable membrane was treated by a freezing superthin section method, that is, cut perpendicularly to the membrane surface direction of the composite semipermeable membrane, and then a cross-sectional image of an obtained superthin section was taken using a transmission electron microscope. The cross-sectional image taken by the transmission electron microscope was taken into image analysis software Image J. An average thickness of the upper portion and the lower portion of the protrusion was measured by the method described above. Further, the number of protrusions was counted, and the average number density of the protrusions was obtained.

### (v) Measurement of O/N Ratio of Protrusion

The superthin section obtained by the freezing superthin section method were observed with a field emission type transmission electron microscope (JEM-2100F manufactured by JEOL) at a magnified scale to show the protrusion as shown in FIG. 4. In the enlarged protrusion (convex portion 6), O and N were measured at a TEM-EELS measurement position M that passes through the apex of the protrusion using an EELS detector (Tridiem manufactured by Gatan) under conditions of an accelerating voltage of 200 kV, energy resolution of 0.8 eV FWHM, and −175 °C. For the measurement, three protrusions were randomly selected from those having an apparent height of one-fifth or more of the ten-point average surface roughness on one cross section. Similar measurements were performed on three randomly selected cross sections, and an arithmetic mean value of O/N ratios was calculated to determine x, which is a mean value of the O/N ratios in the range of 2% to 25% of the apparent height Pah of the protrusion, and y, which is a mean value of the O/N ratios in the range of 75% to 98% of the apparent height Pah of the protrusion.

### Reference Example 1

A 18.0 mass % DMF solution of polysulfone UDEL P-3500 (manufactured by Solvay Advanced Polymers Co., Ltd.) was cast to a thickness of 200 μm under a condition of 25 °C on a polyester nonwoven fabric (air flow rate: 2.0 cc/cm²/sec) as a substrate. This was immediately immersed in pure water and left for 5 minutes to solidify, producing a support membrane having a substrate and a microporous support layer. The total thickness of the substrate and the microporous support layer was 150 μm.

### Example 1

A support membrane obtained in Reference Example 1 was immersed for 2 minutes in a 3.0 mass % m-phenylenediamine aqueous solution. The support membrane was slowly pulled up in a vertical direction, and nitrogen was blown from an air nozzle to remove the excessive aqueous solution from a surface of the support membrane. In an environment controlled to 40 °C, an n-decane solution at 40 °C containing 0.16 mass % of TMC was applied to completely wet the surface of the support membrane. Next, after the support membrane was heated in an oven at 120 °C, in order to remove the excessive solution from the membrane, the membrane was set vertically to remove liquid, and dried by blowing air at 20 °C using a blower. The dried membrane was immersed in a 10 mass % N,N-dimethylformamide aqueous solution as a compound containing an amide group at 25 °C for 2 minutes. Thereafter, the membrane was washed with pure water at 90 °C to obtain a composite semipermeable membrane in Example 1. A height of a protrusion of the composite semipermeable membrane in Example 1 was 102 nm.

### Example 2

A composite semipermeable membrane in Example 2 was obtained in the same manner as in Example 1, except that an oven temperature was set to 150 °C, air was blown onto the membrane to dry the membrane, and then the membrane was immersed in a 30.0 mass % N,N-dimethylformamide aqueous solution at 5 °C for 2 minutes.

### Example 3

A composite semipermeable membrane in Example 3 was obtained in the same manner as in Example 1, except that air was blown onto the membrane to dry the membrane, and then the membrane was immersed in a 10.0 mass % N,N-dimethylformamide aqueous solution at 10 °C for 2 minutes.

### Example 4

A composite semipermeable membrane in Example 4 was obtained in the same manner as in Example 1, except that a temperature of the N,N-dimethylformamide aqueous solution to be contacted was set to 45 °C.

### Example 5

A composite semipermeable membrane in Example 5 was obtained in the same manner as in Example 1 except that the m-phenylenediamine aqueous solution was changed to 6.0 mass %.

### Example 6

A composite semipermeable membrane in Example 6 was obtained in the same manner as in Example 2, except that a concentration of the N,N-dimethylformamide aqueous solution to be contacted was 1.0 mass %.

### Example 7

A composite semipermeable membrane in Example 7 was obtained in the same manner as in Example 1 except that a solution containing the compound containing the amide group to be contacted was changed to ε-caprolactam to prepare a 10.0 mass % ε-caprolactam aqueous solution.

### Example 8

A composite semipermeable membrane in Example 8 was obtained in the same manner as in Example 2 except that a temperature of the n-decane solution of TMC to be applied was changed to 65 °C.

### Example 9

A composite semipermeable membrane in Example 9 was obtained in the same manner as in Example 1, except that an n-decane solution at 40 °C which contains 0.16 mass % TMC and 0.016 mass % isophthalic acid chloride was used as the polyfunctional aromatic acid halide solution.

### Comparative Example 1

A composite semipermeable membrane in Comparative Example 1 was obtained in the same manner as in Example 5, except that the step of bringing the dried membrane into contact with the solution containing the compound having the amide group was not carried out.

### Comparative Example 2

A composite semipermeable membrane in Comparative Example 2 was obtained in the same manner as in Comparative Example 1 except that an n-decane solution at 40 °C containing 0.16 mass % of TMC was applied to completely wet a surface of the support membrane, and then the n-decane solution containing 0.32 weight % of TMC was applied to the support membrane and heated in an oven at 120 °C.

### Comparative Example 3

A composite semipermeable membrane in Comparative Example 3 was obtained in the same manner as in Comparative Example 1 except that isooctane was used as a solvent of a TMC solution, a temperature of the solution was set to 25 °C, the solution was applied in an environment controlled to 25 °C, and a temperature of an oven was set to 150 °C.

### Comparative Example 4

A composite semipermeable membrane in Comparative Example 4 was obtained in the same manner as in Comparative Example 1 except that a step of putting in an oven at 120 °C was omitted, a temperature of an n-decane solution of TMC was set to 25 °C, and the solution was applied in an environment controlled to 25 °C.

### Comparative Example 5

A composite semipermeable membrane in Comparative Example 5 was obtained in the same manner as in Comparative Example 1, except that the membrane was dried by blowing air onto the membrane and then immersed in a 1 mass % tributyl phosphate aqueous solution at 25 °C for 2 minutes.

### Comparative Example 6

A composite semipermeable membrane in Comparative Example 6 was obtained in the same manner as in Comparative Example 1, except that the membrane was dried by blowing air onto the membrane and then immersed in a 10 mass % isopropyl alcohol aqueous solution at 25 °C for 2 minutes.

Results of the above are shown in Table 1. From Examples 1 to 9, it is understood that the composite semipermeable membrane of the present embodiment has high water permeability and salt removability, and a change in salt removability after contact with chlorine is small.

TABLE 1

| | Structure | | | | | | | |
|---|---|---|---|---|---|---|---|---|
| | | | | | Average | Initial performance | | Chlorine |
| | | | | | number | Membrane | Salt | deterioration |
| | | | | | density of | permeation | removal | test |
| | x | y | y/x | T98/T25 | protrusions | flux | rate | SP ratio |
| | — | — | — | — | (protrusions/μm) | (m³/m²/d) | (%) | — |
| Example 1 | 0.57 | 0.92 | 1.6 | 0.89 | 15.9 | 1.07 | 99.80 | 1.55 |
| Example 2 | 0.89 | 1.34 | 1.5 | 0.90 | 12.8 | 1.02 | 99.81 | 1.74 |
| Example 3 | 0.52 | 1.23 | 2.4 | 0.88 | 16.1 | 1.11 | 99.83 | 1.50 |
| Example 4 | 1.00 | 1.31 | 1.3 | 0.98 | 13.3 | 0.95 | 99.81 | 1.86 |
| Example 5 | 0.35 | 0.50 | 1.4 | 0.69 | 13.0 | 0.98 | 99.80 | 1.90 |
| Example 6 | 0.70 | 1.40 | 2.0 | 0.97 | 11.4 | 0.95 | 99.83 | 1.41 |
| Example 7 | 0.52 | 0.94 | 1.8 | 0.82 | 14.7 | 1.04 | 99.81 | 1.58 |
| Example 8 | 0.48 | 0.90 | 1.9 | 0.85 | 10.7 | 0.98 | 99.78 | 1.86 |
| Example 9 | 1.10 | 1.78 | 1.6 | 0.94 | 14.0 | 0.95 | 99.84 | 1.44 |
| Comparative | 0.96 | 1.01 | 1.1 | 0.99 | 12.9 | 0.80 | 99.82 | 2.06 |
| Example 1 | | | | | | | | |
| Comparative | 1.20 | 1.43 | 1.2 | 0.92 | 12.5 | 0.91 | 99.86 | 2.07 |
| Example 2 | | | | | | | | |
| Comparative | 0.39 | 0.43 | 1.1 | 0.97 | 12.7 | 0.95 | 99.63 | 2.05 |
| Example 3 | | | | | | | | |
| Comparative | 1.13 | 1.38 | 1.2 | 0.96 | 18.0 | 0.89 | 99.77 | 2.83 |
| Example 4 | | | | | | | | |
| Comparative | 1.80 | 2.10 | 1.2 | 0.98 | 15.2 | 1.04 | 99.51 | 2.04 |
| Example 5 | | | | | | | | |
| Comparative | 0.79 | 0.89 | 1.1 | 0.94 | 14.0 | 0.98 | 99.67 | 2.09 |
| Example 6 | | | | | | | | |

Although the present invention has been described in detail with reference to specific embodiments, it is apparent to those skilled in the art that various changes and modifications can be made without departing from the spirit and scope of the present invention. The present application is based on Japanese Patent Application No. 2022-137501 filed on Aug. 31, 2022, and the content thereof is incorporated herein by reference. All references cited herein are incorporated as a whole.

### REFERENCE SIGNS LIST

1 composite semipermeable membrane
2 substrate
3 microporous support layer
4 separation functional layer
5 thin film
6 convex portion
A average line of roughness curve
Yp1 to Yp5 elevations of highest to fifth peaks from average line A
Yv1 to Yv5 elevations of lowest to fifth valleys from average line A
L reference length
B position of apex of protrusion
Z position at distance d from average line A
d mean value of distances d1 and d2
d1 distance from average line A to apex of concave portion on left side of protrusion
d2 distance from average line A to apex of concave portion on right side of protrusion
h distance from average line A to apex of protrusion
Ph height of protrusion
T25 average thickness of thin film in range of 2% to 25% of height of protrusion
T98 average thickness of thin film in range of 75% to 98% of height of protrusion
Pah apparent height of protrusion
M TEM-EELS measurement position

1. A composite semipermeable membrane comprising:
a microporous support layer; and
a separation functional layer provided on the microporous support layer, wherein
the separation functional layer includes a plurality of protrusions formed of a thin film containing a crosslinked aromatic polyamide, and
the following x and y, which are measured by an electron energy-loss spectroscopy in a transmission electron microscope (TEM-EELS), satisfy a relation of y/x≥1.3,
provided that x is an average value of a ratio of oxygen atom (O)/nitrogen atom (N) in a range of 2% to 25% of an apparent height of the protrusion, and
y is an average value of the ratio of O/N in a range of 75% to 98% of the apparent height of the protrusion.

2. The composite semipermeable membrane according to claim 1, wherein
y satisfies a relation of y≥0.90.

3. The composite semipermeable membrane according to claim 1, wherein
x satisfies a relation of x≥0.50.

4. The composite semipermeable membrane according to claim 1, wherein
in the separation functional layer, a ratio of T98/T25 is 0.95 or less, provided that T98 is an average thickness of the thin film in a range of 75% to 98% of a height of the protrusion, and
T25 is an average thickness of the thin film in a range of 2% to 25% of the height of the protrusion.

5. The composite semipermeable membrane according to claim 1, wherein
in the separation functional layer, an average number density of the protrusions having a height of one-fifth or more of a ten-point average surface roughness is 13.0 protrusions/μm or more.

6. The composite semipermeable membrane according to claim 1, wherein
the crosslinked aromatic polyamide includes a polyamide which is a polymer of trimesic acid chloride and m-phenylenediamine.

7. A method for producing a composite semipermeable membrane including a microporous support layer and a separation functional layer provided on the microporous support layer, the method comprising:
a step of forming a layer containing a crosslinked aromatic polyamide on the microporous support layer by interfacial polycondensation using a polyfunctional aromatic amine aqueous solution and an organic solvent solution of a polyfunctional aromatic acid halide; and
a step of bringing a solution containing a compound containing an amide group into contact with the layer containing the crosslinked aromatic polyamide.

8. An element comprising the composite semipermeable membrane according to claim 1.

9. A fluid separation device comprising the composite semipermeable membrane according to claim 1.
